(19) United States
(12) Patent Application Publication
(10) Pub. No.: US 2013/0284315 A1
(43) Pub. Date: Oct. 31, 2013

(54) Funnel For A Baby Bottle

(71) Applicant: Florian Enghard, Sulzbach (DE)

(72) Inventor: Florian Enghard, Sulzbach (DE)

(21) Appl. No.: 13/978,944

(22) PCT Filed: Jan. 10, 2012
(86) PCT No.: PCT/EP12/00077

§ 371 Date: Jul. 10, 2013

(30) Foreign Application Priority Data
Jan. 10, 2011 (DE) 102011-008-184.4
Jun. 20, 2011 (DE) 10-2011-105.480.8

(51) Int. Cl. B67C 11/02

(52) U.S. Cl. CPC B67C 11/02
USPC 141/331

(57) ABSTRACT

The invention relates to a funnel for a funnel for a baby bottle, which includes a downwardly narrowing funnel bowl (1) and a funnel nozzle (4), wherein the funnel nozzle (4) encompasses several different diameters which are adapted to different bottle neck diameters and are fixable thereon. The invention is characterized in that the funnel nozzle (4) comprises at least three stepped external diameters that decrease downwardly toward the funnel outlet (10) and are adapted to at least three different bottle neck internal diameters, and in that at least one elastic, inwardly enclosed clamping groove (5) is provided from the funnel bowl (1) to over the funnel shaft (4).

The invention relates to a funnel for a baby bottle according to the preamble of the patent claim 1.

Funnels for baby bottles are provided for filling raw materials preferably like milk powder or instant-type tea components into the tight or narrow openings of baby bottles without scattering or spilling. Today, such baby bottles exist in various different sizes of 125 ml, 240 ml and 330 ml sizes, and are embodied with at least two different neck or mouth widths that are approximately the same worldwide. Thus, baby bottles exist with a normal neck or mouth width of approximately 35 mm external diameter, and a wide neck or mouth width of approximately 45 mm external diameter, which are both used together in most infant households. For that, simple, conically narrowing or tapering plastic funnels without outlet nozzles or connecting pieces are in common usage today, which are insertable into the bottle openings and are preferably offered for the normal neck bottles Because these funnels comprise a fill opening of approximately 50 mm diameter at the top, they are also insertable in the bottle openings of the wide neck or wide mouth bottles. Because these funnels do not have fitted or adapted outlet nozzles, they are not fixable on the bottles and must usually be held manually, which is very cumbersome. Especially in connection with wide neck bottles, the outlet openings of these funnels reach far into the lower bottle body and thus can easily become wetted by the mixture liquid, so that the raw materials easily adhere thereon.

A funnel with an integrated threaded part for standardized threadings is already known from the DE 298 11 696 U1. In this funnel, a downwardly conically narrowing funnel bowl is provided, on which a cylindrical pipe stub is applied, which is insertable into a bottle neck of a baby bottle. A threaded screw head with an internal threading is coaxially secured on this pipe stub, and would be screwable onto an adapted or fitted external threading of a baby bottle for stabilization. This, however, has the disadvantage, that then two different funnels must be available for the two different neck or mouth widths of baby bottles that are typical today.

From the DE 198 06 756 A1 a funnel is already known, which only permits a limited insertion or submersion of the funnel connector stub or nozzle, and achieves a stabilization of the funnel bowl by a collar or jacket around the funnel nozzle. For that purpose, a pipe-shaped collar or jacket is arranged coaxially around the funnel nozzle, and protrudes downwardly axially over the pipe stub and braces or supports itself externally on the widening or expanding bottle neck. This funnel is, however, only fitted or adapted to a provided bottle neck diameter, and would possibly fit onto a smaller bottle neck but would then not be stably braceable.

A funnel that comprises a funnel bowl and a funnel shaft or tube with two different diameters is known from the U.S. Pat. No. 6,425,424 B1. In that regard, the funnel shaft of some embodiments has a smaller diameter below the funnel bowl, and this smaller diameter is connected with a funnel shaft part with a larger diameter that is arranged further downwardly. This funnel is suitable for bottles with two different bottle neck or mouth widths and is adapted or fitted to the diameters thereof. In that regard, the funnel is either screwed onto the threadings of the bottle necks or outwardly pushed or plugged thereon and thus fixed on the bottle. Because these funnels are screwed or plugged onto the external diameter, therefore they must be exactly adapted or fitted to the two different bottle neck threadings or the two other bottle neck exterior shapes, in order to be able to be used.

In another funnel embodiment, the funnel shaft is formed or embodied in such a manner so that it comprises a certain internal diameter and a certain external diameter coaxially to one another, so that it is adapted to the external diameter of a certain normal neck bottle and is adapted to the internal diameter of a certain wide neck or wide mouth bottle. Therefore, such funnels are only suitable for two certain bottle neck diameters.

Therefore, it is the object underlying the invention to improve a funnel for baby bottles so that it is suitable for nearly all arising baby bottles, especially that it can be used similarly both for normal neck or mouth bottles as well as for wide neck or mouth bottles, and makes possible a stabilized filling process.

This object is achieved by the invention set forth in the patent claim 1. Further developments and advantageous example embodiments of the invention are set forth in the dependent claims.

The invention has the advantage, that the funnel can easily be set onto all present commonly used baby bottles, due to the three or more funnel nozzle sections. Thus, due to the at least three different funnel nozzle sections, the funnel is adaptable to typical conventional internal diameter differences of commonly used baby bottles, so that these are well fixable in the bottle neck. Especially, the various different bottle neck internal diameters result from the fact that these are embodied slightly larger in plastic bottles than in glass bottle embodiments of a similar type, so that advantageously, already due to three funnel nozzle sections, the funnel is simultaneously adaptable or fittable on normal neck bottles, wide neck bottles and ultra wide neck bottles, and this both for plastic as well as for glass bottle embodiments.

Through the additional clamping groove, advantageously not only tolerances in the bottle manufacturing, but also the differences between glass and plastic bottles as well as also production differences can be compensated by an elastic squeezing-together.

In that regard, the invention with the clamping groove simultaneously has the advantage that thereby a venting opening is realized, by means of which a uniform filling remains possible even with a tight or sealed clamping in the bottle neck.

A particular embodiment of the invention with funnel nozzle sections tuned or adapted to the opening gap width of the clamping groove has the advantage that thereby the funnel is insertable in a clamped manner on all possible intermediate bottle neck diameters. Thus, with at least three shaft or tube steps and a clamping groove adapted thereto, all possible baby bottle diameters are continuously adjustably selectable in order to plug it in a fixed manner onto the bottle neck.

In a further particular embodiment with several parallel clamping grooves, advantageously all diameter values between the smallest and the largest bottle neck internal diameter are adjustably selectable with relatively small opening gap widths. Therefore, such a funnel has the advantage that it is fixable with small opening gap widths nearly on all conventional typical bottle neck diameters, independently of the bottle producer and independently of the bottle material and the production accuracies thereof.

In a further particular embodiment of the invention, an elastic synthetic plastic material is provided as the funnel material. This especially has the advantage that the funnel thereby is producible in a simple and economical manner as an injection molded part.

The invention is explained in further detail in connection with an example embodiment that is shown in the drawing.

It is shown by:

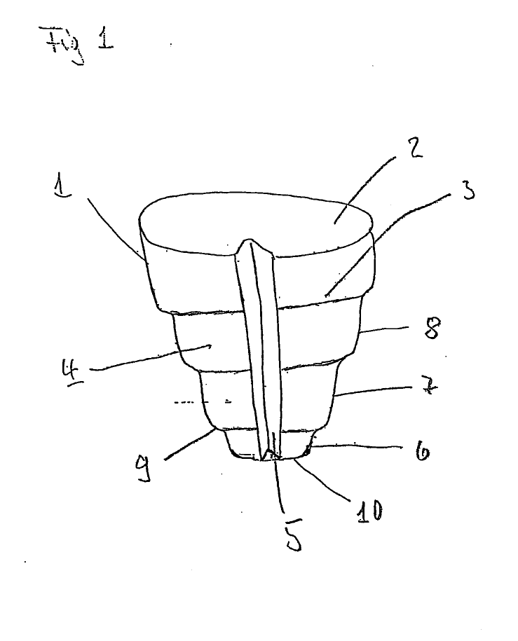

FIG. 1: a funnel with a three-fold stepped-down funnel nozzle or connector piece, and

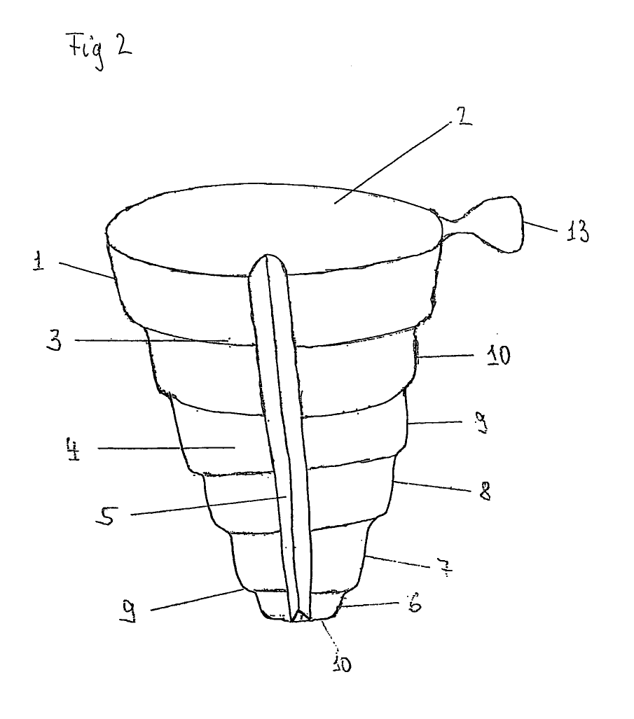

FIG. 2: a funnel with a five-fold stepped-down funnel nozzle or connector piece.

FIG. 1 of the drawing shows a funnel for baby bottles with a funnel bowl 1 and a three-fold stepped-down funnel nozzle or connector piece 4, wherein both the funnel bowl 1 as well as the funnel nozzle 4 have a vertical clamping groove 5 extending therethrough.

The funnel bowl 1 has an upper fill opening 2 and a lower outlet opening or drain opening 3, which flows or discharges into the three-fold stepped-down funnel nozzle 4. The funnel bowl 1 narrows or tapers downwardly and can also be embodied with a conical shape. In that regard, the funnel is provided for baby bottles that have a bottle neck with an internal diameter of approximately 29 mm for normal neck bottles, and approximately 39 mm for wide neck or mouth bottles. Additionally however, ultra wide neck or mouth bottles still further exist, which comprise an internal diameter of the bottle neck of 53 mm, for which the funnel is also suitable. The funnel can, however, also be embodied so that it is usable for bottle necks from approximately 20 to 100 mm.

The three-fold stepped-down funnel nozzle 4 is arranged on the outlet opening 3 of the funnel bowl 1. The funnel nozzle 4 consists of three funnel nozzle sections 6, 7, 8 that become slightly smaller toward the bottom, and that comprise a funnel outlet 10 at the bottom as a termination. The upper funnel nozzle section 8 as the third funnel nozzle section is embodied approximately cylindrically shaped and narrows with regard to its diameter toward the bottom slightly by preferably 2 mm, in order to be simply insertable in a fixable manner into a corresponding bottle neck. The upper funnel nozzle section 8 comprises a maximum external diameter of approximately 39 mm, which is provided for the presently typical wide neck or mouth bottles, that comprise an internal diameter of approximately 39 mm.

The next successive middle funnel nozzle section 7 as the second funnel nozzle section has a maximum external diameter of preferably 34 mm for small wide neck or mouth bottles with external diameters of approximately 30 mm. In comparison, the bottom funnel nozzle section 6 as the third funnel nozzle section is provided with an external diameter of approximately 29 mm for normal neck or mouth bottles with external diameters of 29 mm. All three funnel nozzle sections 6, 7, 8 are connected rigidly with one another via a rounded, sharply narrowing step-down transition element 9, so that it involves a one-piece round funnel.

Furthermore, a linear clamping groove 5 is recessed or let into the circumferential surface of the funnel bowl 1 and the funnel nozzle 4, whereby the clamping groove 5 extends vertically from the fill opening 2 of the funnel bowl 1 to the outlet 10 of the first funnel nozzle 1. The clamping groove 5 is formed-out radially inwardly and is surrounded by an elastic material layer. The elastic material layer preferably gives the clamping groove 5 a U-shaped or V-shaped cross-section. Thereby the clamping groove 5 leaves an opening gap of approximately 6 to 15 mm toward the outside in the outer circumferential surface. Thereby a diameter variation of approximately 2 to 5 mm is possible, which is sufficient to compensate production differences and neck widths between the various different baby bottle producers. Simultaneously, bottle internal diameter differences between bottles of thin-walled plastic or thick-walled glass are also compensateable. With such a funnel, all diameters between approximately 25 and 44 mm can be continuously reconstructed, so that this funnel is usable on all arising baby bottles with internal diameters from 25 to 44 mm.

For the diameter compensation and for securely fixing the funnel in the baby bottles, the funnel preferably consists of an elastic plastic such as, e.g., polyethylene (PE) or polyvinylchloride (PVC), which also can be squeezed together by hand so far until the opening gap is entirely squeezed together on the circumferential surface. Therefore it is still further provided, that the elastic material layer for surrounding or enclosing the clamping groove 5 is embodied thinner by a multiple as compared to the outer wall of the funnel bowl 1 and the funnel nozzle 4, which comprise wall thicknesses of preferably 1 to 2 mm. For the secure fixing of the funnel, the individual funnel nozzle sections 6, 7, 8 preferably comprise an axial length of 10 to 20 mm, which are insertable in a force-transmitting and shape-mating manner in the various different bottle necks.

For being adaptable to a larger range of bottle neck widths, that go beyond the elastic size reduction range of 25 to 44 mm, four or more-stepped funnel nozzle sections can also be provided. For enlarging the adaptation ability of the funnel to larger diameter differences, funnels can also be equipped with two or three clamping grooves. In a funnel with two or three clamping grooves, a continuous adaptation over the entire range of the diameter between e.g. 29 to 53 mm internal neck diameter is possible. With an enlargement of the gap widths up to approximately 20 mm, also the three-stepped funnel with only one clamping groove 5 can be continuously set onto all possible baby bottles with bottle internal diameters from 29 to 53 mm.

A funnel for baby bottles with a funnel bowl 1 and a five-fold stepped-down funnel nozzle is illustrated in FIG. 2 of the drawing, wherein this funnel has a clamping groove 5 extending through it from the funnel bowl 1 to the smallest and first funnel nozzle 6. Thereby, in this example embodiment according to FIG. 2, the functionally equivalent funnel parts have the same reference numbers as for the funnel according to FIG. 1 of the drawing. Thus, the funnel similarly includes at the top a funnel bowl 1, which comprises a fill opening 2 and an outlet or drain opening 3, and is embodied slightly conically tapered toward the bottom. The funnel bowl 1 still additionally includes a grip tongue or handle tab 13, which is arranged flaring laterally outwardly at the upper rim of the funnel bowl 1 and is provided for setting-on or pulling-off the fixed funnel.

The five stepped-down funnel nozzle sections 6, 7, 8, 11, 12 are arranged below the funnel bowl 1, and are connected with the funnel bowl 1 by means of an integrated stepped-down transition element 9. The bottom and first funnel nozzle section 6 internally has a diameter of approximately 29 mm and at the upper end of the section has an external diameter of approximately 34 mm, and is thus able to be set onto at least an internal bottle neck diameter of approximately 30 mm. This follows from a clamping groove 5 with a width of approximately 15.7 mm, through which the external diameter of the funnel nozzle section 6 can be made smaller by approximately 5 mm. Because the first funnel nozzle section 6 with a length of approximately 10 to 20 mm additionally conically tapers by 1 to 2 mm and comprises a conical wedge shaped plug-on or push-on rim, it can also be plugged onto baby bottles with a clear open width of 28 mm.

The second funnel nozzle section 7 following the stepped-down transition element 9 has at the top an external diameter of approximately 39 mm, so that with the clamping groove width remaining the same at approximately 5 mm it is fixable in a clamped manner by insertion onto bottles with internal neck diameters of 34 to 39 mm. The third funnel nozzle section 8 has at the top an external diameter of approximately 44 mm, so that with a pressed-together clamping groove 5 and a slightly conical axial shaft progression it is suitable for bottle necks of 38 to 44 mm internal diameter. The fourth funnel nozzle section 11 that next follows after the further step-down transition element 9 comprises at the top an external diameter of approximately 49 mm and can thus be set or plugged onto bottle internal diameters of 43 to 49 mm in a clamped manner.

The fifth funnel nozzle section 12 is arranged after the fourth following stepped-down transition element 9, and comprises an upper external diameter of 54 mm and thus is suitable also for ultra-wide neck bottles of 48 to 54 mm bottle neck diameter. Because in the present embodiment the funnel bowl 1 is embodied similarly as the individual funnel nozzle sections 6, 7, 8, 11, 12, this funnel can also still further be set or plugged in a clamped manner onto baby bottles with larger external neck diameter. The funnel bowl 1 can, however, also be equipped with a sharply conical shape with a large filling diameter up to 100 mm, so that thereby larger and thus well-fillable fill openings 2 result.

Such a funnel can also be embodied so that it is not only limited to baby bottles, but also can be set or plugged in a clamped manner onto smaller or larger beginning or end diameters of approximately 20 to 100 mm.

1. Funnel for a baby bottle, which includes a downwardly narrowing funnel bowl (1) and a funnel nozzle (4), wherein the funnel nozzle (4) encompasses several different diameters which are adapted to several different bottle neck diameters and are fixable thereon, characterized in that the funnel nozzle (4) comprises at least three stepped external diameters that decrease downwardly toward the funnel outlet (10) and are adapted to at least three different bottle neck internal diameters, and in that at least one elastic inwardly enclosed clamping groove (5) is provided from the funnel bowl (1) to over the funnel shaft (4).

2. Funnel according to claim 1, characterized in that the width of the clamping groove (5) (opening gap) is adapted to the diameters of the stepped-down funnel nozzles (6, 7, 8, 11, 12) so that thereby at least all diameter values possible between the smallest and the largest external diameter of the funnel nozzle sections (6, 7, 8, 11, 12) are adjustably selectable.

3. Funnel according to claim 1, characterized in that the stepped funnel nozzle (4) forms, through the narrowing external diameters, at least three funnel nozzle sections (6, 7, 8, 11, 12) which are respectively embodied approximately cylindrically shaped and taper downwardly slightly conically or in a spherical or crowned or bulging shape.

4. Funnel according to claim 3, characterized in that a transition element (9) is arranged between the upper end of the smaller funnel nozzle section (6, 7, 8, 11) and the larger funnel nozzle section (7, 8, 11, 12), and comprises a sharply conical or an inwardly rounded transition region with continuously expanding diameters.

5. Funnel according to claim 1, characterized in that the funnel comprises five stepped-down funnel nozzle sections (6, 7, 8, 11, 12) with external diameters 26 to 54 mm, and said at least one clamping groove includes at least one vertical clamping groove (5) of which the external gap width (opening gap) amounts to between 10 to 20 mm.

6. Funnel according to claim 1, characterized in that the clamping groove (5) inwardly comprises a V-shaped or U-shaped cross-section and outwardly forms a linear opening.

7. Funnel according to claim 6, characterized in that the linear opening comprises a parallel uniform constant or V-shaped upwardly expanding opening.

8. Funnel according to claim 1, characterized in that said at least one clamping groove comprises several parallel clamping grooves (5).

9. Funnel according to claim 1, characterized in that each one of the funnel bowl (1), the step-down elements (9), and the funnel shaft (4) consists of an elastic, manually easily deformable synthetic plastic or metal, which is rigid in an axial direction.
